(19) United States
(12) Patent Application Publication
(10) Pub. No.: US 2026/0133282 A1
(43) Pub. Date: May 14, 2026

(54) WORKING VEHICLE

(71) Applicant: Kubota Corporation, Osaka-shi (JP)

(72) Inventors: Kenta TAKAYA, Sakai-shi (JP); Kazutaka FUJIMOTO, Sakai-shi (JP); Susumu TAKEOKA, Sakai-shi (JP); Shuya UEDA, Sakai-shi (JP); Tomoya OMURA, Sakai-shi (JP)

(21) Appl. No.: 19/442,151

(22) Filed: Jan. 7, 2026

Related U.S. Application Data
(63) Continuation of application No. PCT/JP2024/015913, filed on Apr. 23, 2024.

(30) Foreign Application Priority Data
Aug. 2, 2023 (JP) 2023-126590

(51) Int. Cl. G01S 7/02; G01S 13/08

(52) U.S. Cl. CPC G01S 7/027; G01S 13/08

(57) ABSTRACT

A working vehicle includes a radar main body to emit radio waves to be used for detection, an attachment stay to which the radar main body is fixed and which is attached to a vehicle body, and a radar cover that is fixed to the attachment stay, covers an emission surface of the radar main body to emit the radio waves, and is capable of transmitting the radio waves.

### CROSS REFERENCE TO RELATED APPLICATIONS

This application claims the benefit of priority to Japanese Patent Application No. 2023-126590 filed on Aug. 2, 2023 and is a Continuation Application of PCT Application No. PCT/JP 2024/015913 filed on Apr. 23, 2024. The entire contents of each application are hereby incorporated herein by reference.

### BACKGROUND OF THE INVENTION

### 1. Field of the Invention

The present invention relates to techniques for working vehicles.

### 2. Description of the Related Art

Techniques for working vehicles to detect a detection target around the vehicle body have been known. For example, JP 2023-078903 A discloses such a configuration. JP 2023-078903 A discloses a working vehicle including a ridge identifying unit that detects and identifies an obstacle such as a ridge in front of the vehicle body. The ridge identifying unit includes a sensor such as a distance measuring sensor.

A distance measuring sensor such as the one mentioned above detects an obstacle by transmitting radio waves such as millimeter waves, and receiving the radio waves reflected by the obstacle to be detected. Here, in a case where foreign matter adheres to the portion of the distance measuring sensor that transmits and receives radio waves, it might be difficult to detect a detection target.

### SUMMARY OF THE INVENTION

Example embodiments of the present invention provide working vehicles each capable of suitably detecting a detection target, using radio waves.

A working vehicle according to an example embodiment of the present disclosure is a working vehicle that includes a detector to detect a detection target around the vehicle body. The detector includes a radar to emit a radio wave to be used for detection, an attachment stay to which the radar is fixed, and which is attached to the vehicle body, and a radar cover that is fixed to the attachment stay, covers an emission surface of the radar, and is capable of transmitting the radio wave. The emission surface is configured to emit the radio wave.

According to an example embodiment of the present disclosure, it is possible to suitably detect a detection target, using radio waves.

A working vehicle according to an example embodiment of the present disclosure further includes a seal that closes a gap between the radar cover and the attachment stay.

According to an example embodiment of the present disclosure, the seal is provided, and thus, dust and water can be prevented from entering from the gap between the radar cover and the attachment stay.

In a radar cover according to an example embodiment of the present disclosure, a portion through which the radio wave passes has a uniform thickness.

According to an example embodiment of the present disclosure, accuracy of detection using radio waves can be further increased.

A working vehicle according to an example embodiment of the present disclosure further includes an attenuator to attenuate a sidelobe wave generated on the outer side of a detection range, the sidelobe wave being included in the radio wave emitted by the radar.

According to an example embodiment of the present disclosure, accuracy of detection using radio waves can be further increased.

The attenuator according to an example embodiment of the present disclosure includes a main body portion including a detection range surface extending along the detection range of the radar, and a radio wave absorber provided on the detection range surface.

According to an example embodiment of the present disclosure, it is possible to prevent detection of a structure or the like outside the detection range, and further increase accuracy of detection.

A working vehicle according to an example embodiment of the present disclosure further includes an insertion portion that is inserted into holes in the main body portion and the radio wave absorber.

According to an example embodiment of the present disclosure, positioning of the radio wave absorber with respect to the main body portion can be performed with the use of the insertion portion.

The detector according to an example embodiment of the present disclosure includes a front detector provided on the front side of the vehicle body, and a back detector provided on the back side of the vehicle body. In the front detector and the back detector, at least one of the radar or the radar cover has a same configuration.

According to an example embodiment of the present disclosure, the front and back detectors can use each other's radar or radar cover, and thus, cost reduction can be achieved.

The detector according to an example embodiment of the present disclosure includes a left detector provided on the left side of the vehicle body, and a right detector provided on the right side of the vehicle body. In the left detector and the right detector, at least one of the radar or the radar cover has a same configuration.

According to an example embodiment of the present disclosure, the left and right detectors can use each other's radar or radar cover, and thus, cost reduction can be achieved.

According to example embodiments of the present disclosure, it is possible to suitably detect a detection target, using radio waves.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view showing the overall configuration of a tractor according to an example embodiment of the present disclosure.

FIG. 2 is a plan view showing the overall configuration of the tractor.

FIG. 3 is a front view of the tractor.

FIG. 4 is a perspective view showing a front portion of a hood, a front radar assembly, a front support, and a design cover.

FIG. 5 is an exploded perspective view showing a machine body frame, the front radar assembly, the front support, and the design cover.

FIG. 6 is an exploded perspective view of the front radar assembly.

FIG. 7 is a front view of the front support.

FIG. 8 is a plan view showing a state in which the design cover is used as a mark indicating a ridge width or the like.

FIG. 9 is a perspective rear view showing a rear portion of the roof of the cabin, a back radar assembly, and a back support.

FIG. 10 is an exploded perspective rear view showing the back radar assembly and the back support.

FIG. 11 is a left cross-sectional view showing the rear portion of the roof of the cabin, the back radar assembly, and a back support.

FIG. 12 is a perspective view showing a left-side portion of the cabin and a left radar assembly.

FIG. 13 is a perspective view showing front pillars, the left radar assembly, and a right radar assembly.

FIG. 14 is a front cross-sectional view showing a front pillar and the left radar assembly.

FIG. 15 is a plan view showing the detection ranges of the respective radar assemblies.

### DETAILED DESCRIPTION OF THE EXAMPLE EMBODIMENTS

In the following description, directions indicated by an arrow U, an arrow D, an arrow F, an arrow B, an arrow L, and an arrow R in the drawings are defined as an upward direction, a downward direction, a frontward direction, a backward direction, a leftward direction, and a rightward direction, respectively.

First, the overall configuration of a tractor 1 according to an example embodiment of the present disclosure is described.

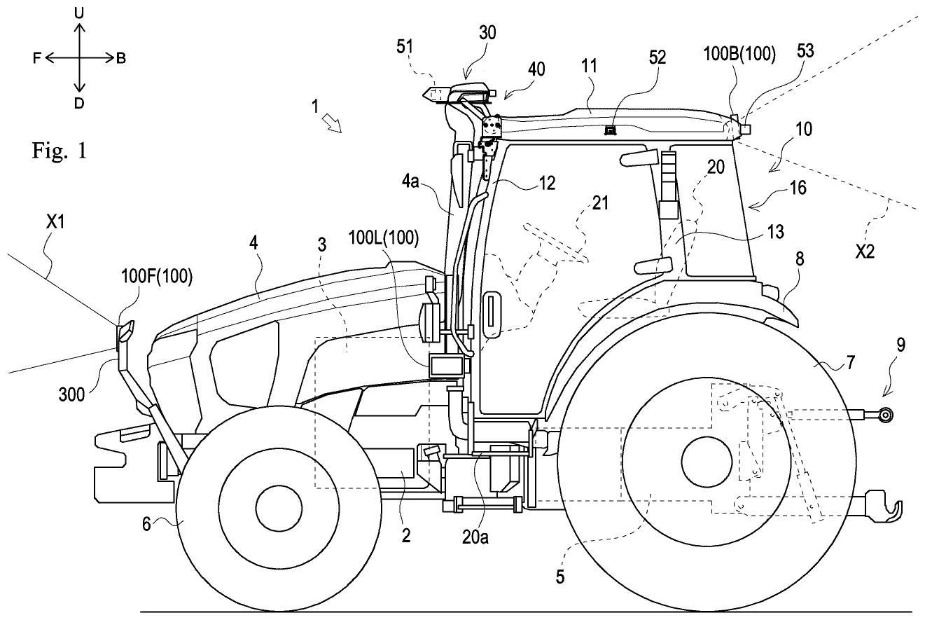

The tractor 1 shown in FIG. 1 mainly includes a machine body frame 2, an engine 3, a hood 4, a transmission casing 5, front wheels 6, rear wheels 7, a fender 8, a lifting device 9, a cabin 10, a seat 20, a steering wheel 21, and the like.

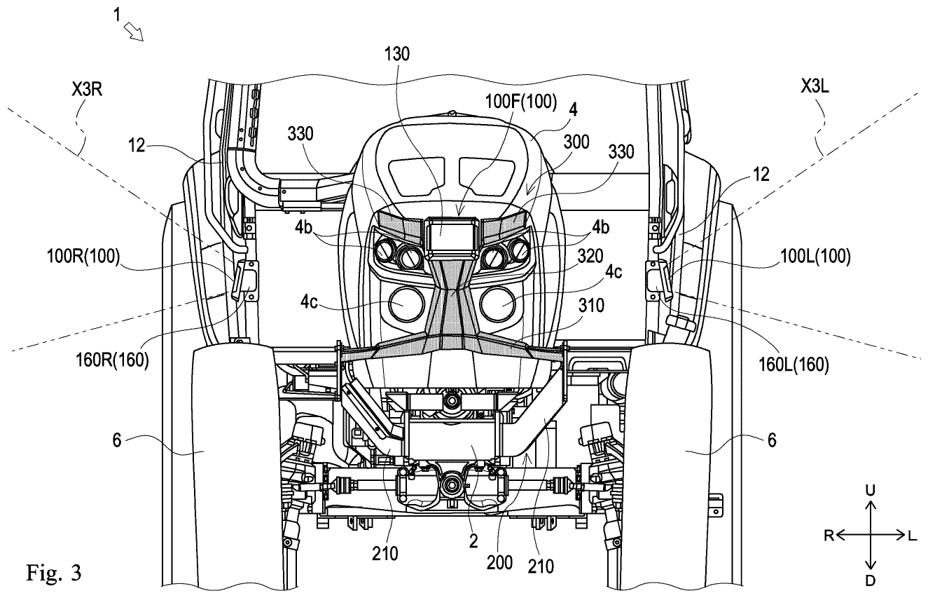

The machine body frame 2 is a frame-shaped structure formed by appropriately combining a plurality of panel structural elements. The machine body frame 2 preferably has a substantially rectangular shape in a planar view. The machine body frame 2 is located in a front portion of the tractor 1, with its longitudinal direction oriented in the front-back direction. The engine 3 is fixed to a rear portion of the machine body frame 2. The engine 3 is covered with the hood 4. The transmission casing 5 is fixed to a rear portion of the engine 3. A muffler 4a that discharges exhaust gas from the engine 3 is located on the right side of the hood 4. Further, as shown in FIG. 3, working lamps 4b and headlights 4c are provided on the front surface of the hood 4. The working lamps 4b and the headlights 4c are provided on both left and right sides of the front surface of the hood 4 at intervals in a lateral direction.

The front portion of the machine body frame 2 is supported by the pair of left and right front wheels 6 through a front axle mechanism (not shown). The rear portion of the transmission casing 5 is supported by the pair of left and right rear wheels 7 through a rear axle mechanism (not shown). The pair of left and right rear wheels 7 is covered with the fender 8 substantially from above.

The lifting device 9 is provided at the rear portion of the transmission casing 5. Various working devices (such as a cultivator, for example) can be attached to the lifting device 9. The lifting device 9 can lift up and down an attached working device with an actuator such as a hydraulic cylinder. Power of the engine 3 can be transmitted to the lifting device 9 through a PTO shaft (not shown).

Power of the engine 3 can be transmitted to the front wheels 6 via the front axle mechanism and be transmitted to the rear wheels 7 via the rear axle mechanism, after being shifted by a transmission (not shown) housed in the transmission casing 5. The front wheels 6 and the rear wheels 7 are rotationally driven by the power of the engine 3, so that the tractor 1 can move. Also, the working device attached to the lifting device 9 can be driven by the power of the engine 3.

The cabin 10 is provided behind the engine 3. The cabin 10 is placed on a vehicle body (such as the transmission casing 5). The living space the driver gets in is located inside the cabin 10.

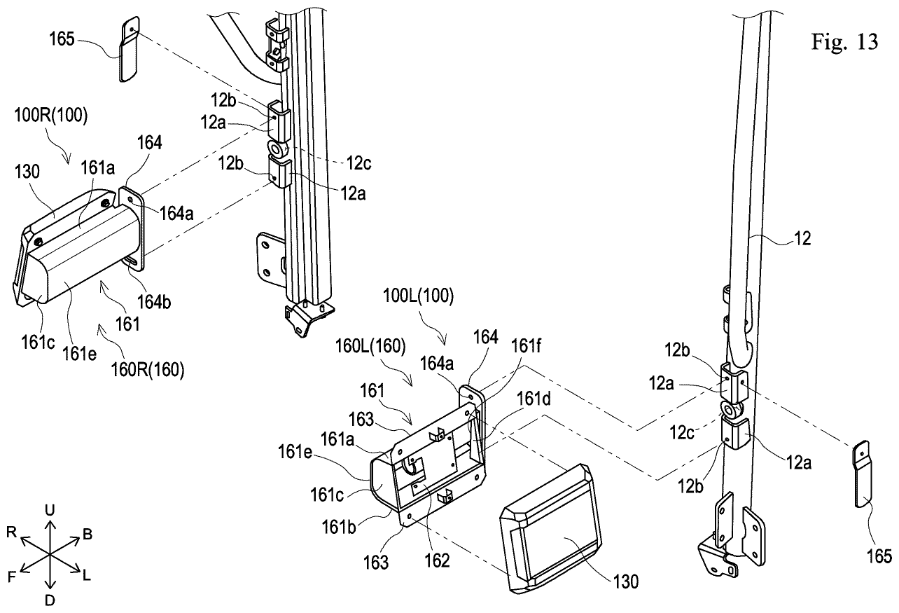

As shown in FIG. 1, the cabin 10 has left and right front pillars 12 that support a roof 11 at the front portion. Fixing portions 12a to fix a left radar assembly 100L and a right radar assembly 100R to be described later are provided at middle portions of the left and right front pillars 12 in a vertical direction (see FIG. 13). The fixing portions 12a are located on the front surfaces of the front pillars 12. The cabin 10 also has left and right rear pillars 13 that support the roof 11 at the rear portion.

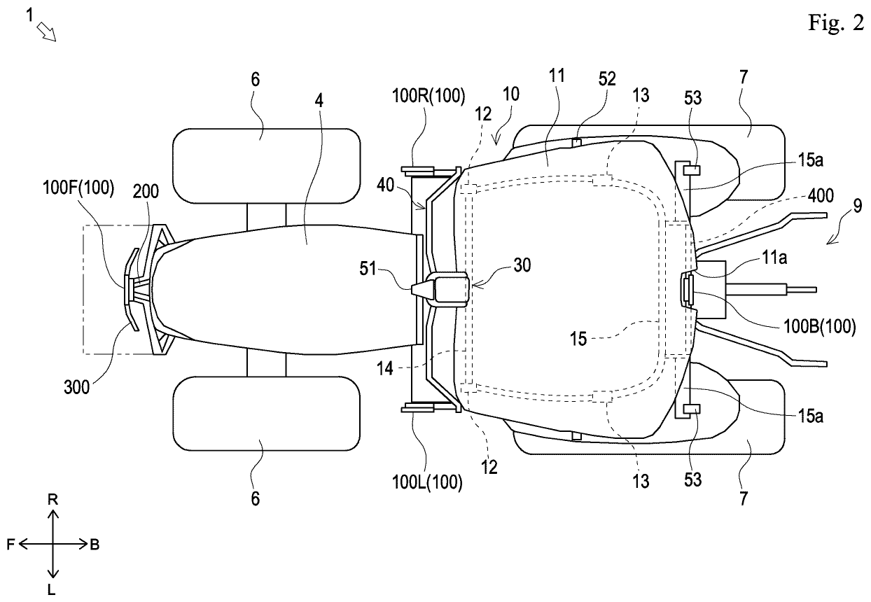

As shown in FIG. 2, the cabin 10 includes a front beam 14 that connects the upper ends of the front pillars 12 to each other. A windshield is provided in the frame including the front beam 14 and the left and right front pillars 12. The cabin 10 also includes a rear beam 15 that connects the upper ends of the rear pillars 13 to each other. Further, as shown in FIG. 1, an openable and closable rear hatch 16 is provided at the rear portion of the cabin 10. The rear hatch 16 is rotatably supported at the rear end of the rear beam 15. Furthermore, as shown in FIG. 2, a pair of stays 15a to which appropriate structural elements can be attached is provided on the rear surface of the rear beam 15, with a distance being kept between the stays 15a in the lateral direction. Working lamps, a low-speed vehicle mark, and the like are provided on the stays 15a.

The front pillars 12, the rear pillars 13, the front beam 14, and the rear beam 15 are hollow. Wiring lines connected to devices (for example, radar assemblies 100 to be described later) provided in the tractor 1 can be inserted into the internal space defined by the respective pillars and the respective beams.

As shown in FIG. 1, the seat 20 on which the driver is to sit is located substantially at the center of the cabin 10. Also, an auxiliary step 20a for getting on and off the seat 20 is attached to the cabin 10. The auxiliary step 20a is installed at least on the left side of the cabin 10. Note that the auxiliary step 20a can be installed on both sides of the cabin 10. Further, the steering wheel 21 to adjust the turning angle of the front wheels 6 is located in the front portion of the cabin 10.

Also, as illustrated in FIGS. 1 and 2, the tractor 1 includes a position detecting device 30 to detect the position of the vehicle body, cameras (a front camera 51, side cameras 52, and back cameras 53) capable of capturing images of the surroundings of the vehicle body, and radar assemblies 100 to detect a detection target that is present around the vehicle body.

The position detecting device 30 is a device to detect the position (location information including the latitude and longitude) of the vehicle body, using a satellite positioning system such as a GPS, various sensors, or the like. The tractor 1 can perform control to autonomously steer the vehicle body, on the basis of the location information detected by the position detecting device 30. The above control includes control to autonomously steer the vehicle body so as to travel straight in parallel to a predetermined traveling reference line that has been set, and control to autonomously drive the vehicle body along a created target traveling route, for example.

The position detecting device 30 is supported by a support mechanism 40 attached to the cabin 10. The support mechanism 40 extends across the left and right front pillars 12. The support mechanism 40 is located in front of the roof 11. Also, the support mechanism 40 is designed to be able to rotate, with respect to the left and right front pillars 12, about a central axis extending in the lateral direction, through left and right connecting portions. Note that the support mechanism 40 may be fixed to the left and right front pillars 12 in a non-rotatable manner. As shown in FIG. 2, the position detecting device 30 is located substantially at the center of the support mechanism 40 in the lateral direction.

A plurality (for example, five in the present example embodiment) of cameras (the front camera 51, the side cameras 52, and the back cameras 53) shown in FIGS. 1 and 2 is provided in the cabin 10. Specifically, the front camera 51 is provided in a front portion (more specifically, the portion corresponding to the one side on the front of the cabin 10 with a rectangular shape in a planar view) of the cabin 10. The pair of left and right side cameras 52 is provided on both left and right side portions (more specifically, the portion corresponding to the left and right sides of the cabin 10 with a rectangular shape in a planar view) of the cabin 10. The pair of left and right back cameras 53 is provided at a rear portion (more specifically, the portion corresponding to the one side on the back side of the cabin 10 with a rectangular shape in a planar view) of the cabin 10.

Each camera is arranged so as to face downward at an angle of approximately 45 degrees with respect to level ground. By making angles uniform in this manner, it is possible to improve the distance measurement performance of each camera, and optimize the field of view of each camera.

As each of the above cameras is used, images of views ahead of, on both the left and right sides of, and behind the tractor 1 can be captured. The tractor 1 can control the operation of the vehicle body, on the basis of the images captured by the respective cameras. For example, it is possible to learn the appearance of a person on the basis of images captured by the respective cameras, and perform control to stop the tractor 1 when the person approaches the vicinity of the tractor 1 on the basis of the results of imaging performed by the respective cameras. Note that the use of the respective cameras is not limited to this, and captured images can be used for various purposes.

In the following, the radar assemblies 100 are described. The radar assemblies 100 can detect a detection target within a predetermined detection range. Examples of detection targets include a structure made of metal or concrete, another vehicle, a person, and the like.

As shown in FIGS. 1 and 2, in the present example embodiment, a plurality of (for example, four) radar assemblies 100 (a front radar assembly 100F, a back radar assembly 100B, the left radar assembly 100L, and the right radar assembly 100R) is provided in the tractor 1. Specifically, the front radar assembly 100F is provided on a front portion of the hood 4 of the tractor 1. Also, the back radar assembly 100B is provided on a rear portion of the cabin 10. Further, the left radar assembly 100L is provided on a left portion of the cabin 10, and the right radar assembly 100R is provided on a right portion of the cabin 10.

In the following, the configurations of the respective radar assemblies 100 are described in order. Note that, of the radar assemblies 100, the front radar assembly 100F and the back radar assembly 100B are designed to have configurations similar to each other. Furthermore, the left radar assembly 100L and the right radar assembly 100R are symmetrical to each other. Therefore, in the following description of the respective radar assemblies 100, explanation of a configuration similar to a configuration already described or bilaterally symmetrical configurations will not be made where appropriate.

Further, the respective radar assemblies 100 each include elements (a radar main body 110, an attenuator 120, a radar cover 130, and a seal 140, all of which will be described later) that are components similar among these radar assemblies. Therefore, in the following description, when the structural elements of one radar assembly 100 (the front radar assembly 100F, for example) are described, the structural elements of another radar assembly 100 (the back radar assembly 100B, the left radar assembly 100L, or the like) will be described in some cases with reference to the drawings.

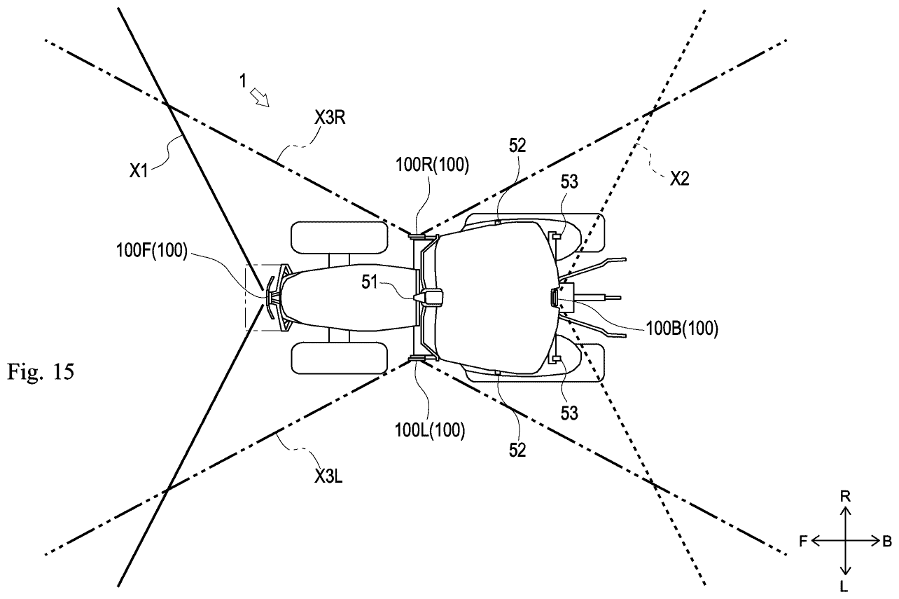

The front radar assembly 100F shown in FIGS. 1 to 6 can detect a detection target that is present in front of the tractor 1. The front radar assembly 100F is located in front of the hood 4. The front radar assembly 100F faces substantially frontward. With this arrangement, the front radar assembly 100F can perform detection in the detection range (a front detection range X1) in front of the hood 4 (see FIGS. 1 and 15). The front radar assembly 100F includes a radar main body 110, an attenuator 120, a radar cover 130, a seal 140, and an attachment stay 150.

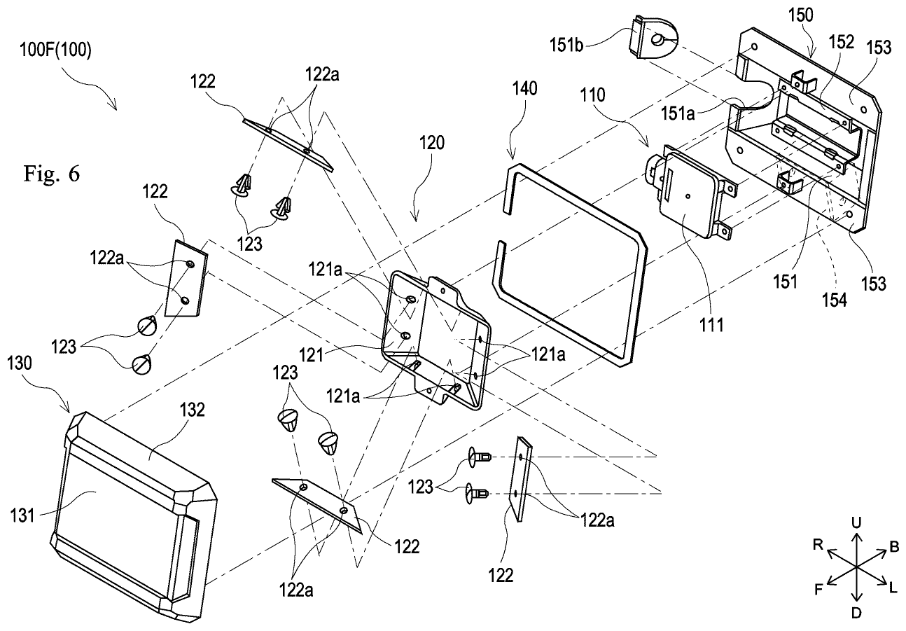

The radar main body 110 shown in FIG. 6 detects a detection target, using radio waves (millimeter waves, for example). Specifically, the radar main body 110 emits radio waves, and receives radio waves reflected by a detection target, to detect the detection target. As the radar main body 110, a millimeter wave sensor can be adopted. The radar main body 110 is fixed to the attachment stay 150 described later. The radar main body 110 has an emission surface 111 to emit radio waves. The radar main body 110 is positioned so that the emission surface 111 faces substantially frontward. The emission surface 111 preferably has a substantially rectangular shape in a front view. Wiring lines (not shown) are connected to the radar main body 110 as appropriate.

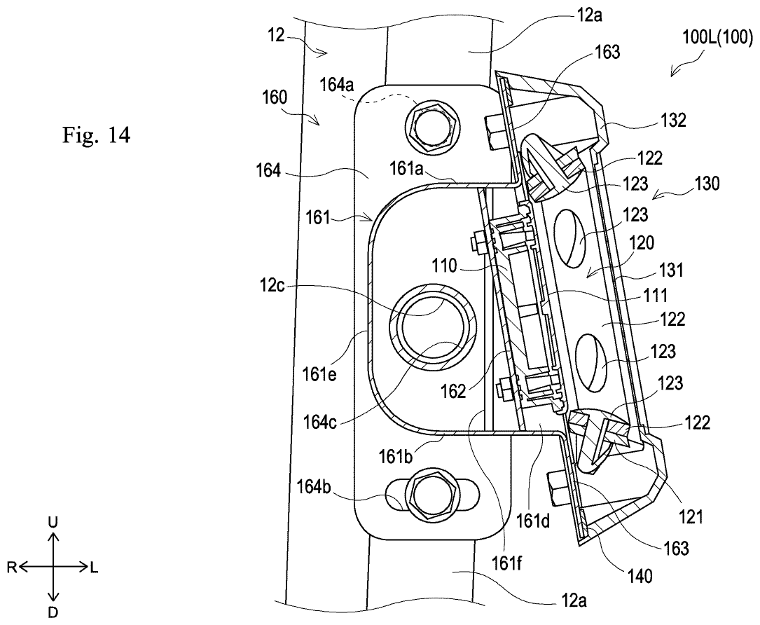

Of the radio waves from the radar main body 110, the attenuator 120 can attenuate sidelobe waves generated outside the detection range. The attenuator 120 preferably has a cylindrical shape that is a substantially quadrangular frustum. The attenuator 120 is open in the front-back direction. Also, the attenuator 120 is formed so that the sidewalls of the cylindrical portion are wider in the vertical direction and the lateral direction at a position farther ahead in the (frontward) direction of radio wave emission. The attenuator 120 is located in front of the emission surface 111 of the radar main body 110 (see FIG. 14). The attenuator 120 is positioned so that its rear opening overlaps the emission surface 111 of the radar main body 110 when viewed from a direction perpendicular to the emission surface 111 (in a substantially front view). The attenuator 120 is fixed to the attachment stay 150 described later. The attenuator 120 includes a main body portion 121, radio wave absorbers 122, and rivets 123.

The main body portion 121 is the main structural body of the attenuator 120. That is, the main body portion 121 preferably has a cylindrical shape that is a substantially quadrangular frustum. The main body portion 121 preferably includes resin, for example. The inner surfaces of the four sidewalls of the main body portion 121 are provided substantially along the detection range (front detection range X1). Holes 121a penetrating the respective sidewalls are provided in the four sidewalls. Two holes 121a are provided in each sidewall.

The radio wave absorbers 122 absorb sidelobe waves on the inner surface side of the main body portion 121. As the radio wave absorbers 122, it is possible to adopt a radio-wave absorbing material (RAM) having high radio wave absorption performance in a radio wave frequency band (79 GHz band, for example) that is used by the radar main body 110. Note that the material of the radio wave absorbers 122 can be changed as appropriate, depending on the radio wave frequency band used by the radar main body 110.

The radio wave absorbers 122 preferably are sheet-shaped. The radio wave absorbers 122 preferably have shapes corresponding to those of the inner surfaces of the four sidewalls of the main body portion 121, and are fixed to the inner surfaces of the respective sidewalls. The radio wave absorbers 122 are bonded to the inner surfaces of the main body portion 121 with a double-sided tape, an adhesive, or the like, for example. Holes 122a corresponding to the holes 121a of the main body portion 121 are provided in the radio wave absorbers 122.

The rivets 123 are inserted into the holes 121a of the main body portion 121 and the holes 122a of the radio wave absorbers 122. The rivets 123 each include a shaft portion to be inserted into the hole 121a and the hole 122a, and a head portion made larger in diameter than the shaft portion. Further, a retaining portion that prevents the rivet from coming off the main body portion 121 is provided at the shaft portion of each of the rivets 123. The rivets 123 include resin, for example. As the rivets 123 are inserted into the holes 121a and the holes 122a, the radio wave absorbers 122 can be positioned with respect to the main body portion 121. Furthermore, as the rivets 123 are provided, the radio wave absorbers 122 can be prevented from coming off the main body portion 121.

The radar cover 130 covers the emission surface 111 of the radar main body 110, and the attenuator 120. The radar cover 130 preferably has a substantially box-like shape that is open toward the back. The radar cover 130 is configured to accommodate the attenuator 120 in an internal space (see FIG. 14). The radar cover 130 is made of a material through which radio waves (electromagnetic waves) from the radar main body 110 can pass. In the present example embodiment, the radar cover 130 is made of resin. The radar cover 130 includes a covering portion 131 and an outside portion 132.

Radio waves from the emission surface 111 of the radar main body 110 pass through the covering portion 131. The covering portion 131 overlaps the emission surface 111 in a substantially front view. In the present example embodiment, the covering portion 131 is wider than the emission surface 111. The thickness (front-rear dimension) of the covering portion 131 is substantially uniform (see FIG. 14). The covering portion 131 is parallel to the emission surface 111. In a case where the thickness of the covering portion 131 is uneven, there is a possibility that detection by the radar main body 110 will be adversely affected. As the thickness of the covering portion 131 is substantially uniform as in the present example embodiment, it is possible to increase the accuracy of detection by the radar main body 110.

The outside portion 132 is a portion on the outer side of the covering portion 131, and the outside portion 132 preferably has a frame-shaped shape that surrounds the four peripheral portions of the covering portion 131. The thickness of the outside portion 132 is greater than the thickness of the covering portion 131.

The seal 140 closes the gap between the radar cover 130 and the attachment stay 150 to be described later. The seal 140 preferably has a frame-shaped shape corresponding to the shape of the opening of the rear portion of the radar cover 130. Note that, in the present example embodiment, part of the right portion of the seal 140 is cut away so as to avoid a grommet 151b to be described later. As the seal 140 is provided, it is possible to prevent dust and water from entering the gap between the radar cover 130 and the attachment stay 150.

The attachment stay 150 has the radar main body 110, the attenuator 120, and the radar cover 130 fixed thereto, and is attached to the vehicle body of the tractor 1. The attachment stay 150 includes a metallic or resin material. The attachment stay 150 includes an accommodating portion 151, a radar fixing portion 152, cover fixing portions 153, and a connecting portion 154.

The accommodating portion 151 is a portion that accommodates the radar main body 110. The accommodating portion 151 preferably has a substantially box-shaped configuration that is open substantially frontward. The accommodating portion 151 preferably has a substantially rectangular shape in a front view. A cutout 151a for drawing out the wiring lines of the radar main body 110 is provided in the right sidewall of the accommodating portion 151. The cutout 151a is formed by cutting the sidewall rearward from the front end. The grommet 151b to protect the wiring lines is attached to the cutout 151a. The grommet 151b is preferably made of a flexible material such as rubber. In the present example embodiment, the front portion of the grommet 151b is located in a cutout portion of the seal 140. The front portion of the grommet 151b, together with the seal 140, closes the gap between the radar cover 130 and the attachment stay 150.

The radar fixing portion 152 fixes the radar main body 110 in the accommodating portion 151. The radar fixing portion 152 is provided on the rear-side wall of the accommodating portion 151. The radar main body 110 is fixed to the radar fixing portion 152 with fasteners such as bolts.

The cover fixing portions 153 are portions to fix the radar cover 130. The cover fixing portions 153 extend upward and downward from the opening of the accommodating portion 151. The cover fixing portions 153 preferably have a substantially plate-like shape, with the plate surfaces facing substantially the front-back direction. The radar cover 130 is fixed to the cover fixing portions 153 with fasteners such as bolts. The seal 140 is located between the cover fixing portions 153 and the radar cover 130. Further, the attenuator 120 (the main body portion 121) is fixed to the cover fixing portions 153. The main body portion 121 is fixed to the cover fixing portions 153 with fasteners such as bolts.

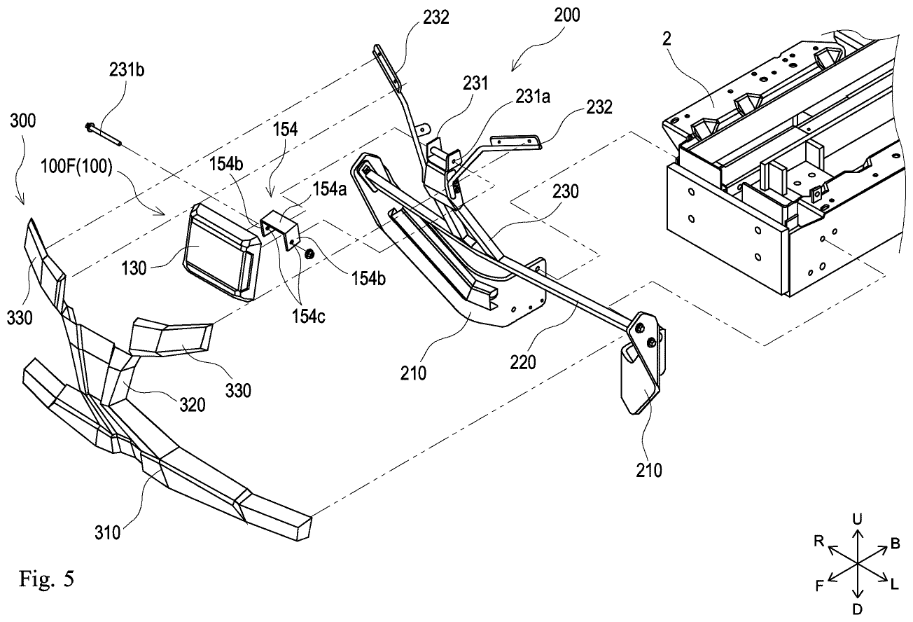

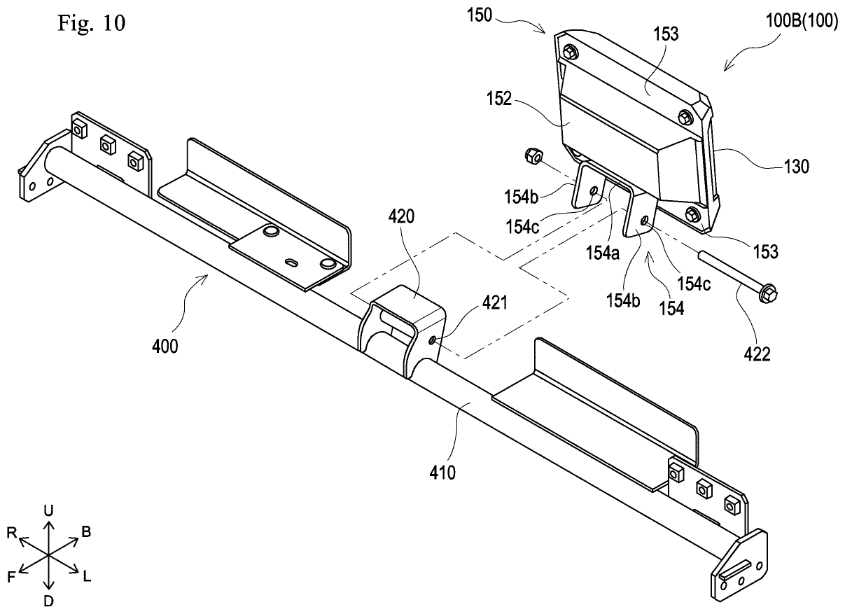

The connecting portion 154 shown in FIG. 5 is a portion to be connected to a front support 200 described later. Note that the connecting portion 154 will be described later with reference also to FIG. 10 showing the attachment stay 150 of the back radar assembly 100B. The connecting portion 154 is provided so as to protrude downward from the lower surface of the accommodating portion 151. The connecting portion 154 is formed by bending a metallic plate substantially into a U-shape. The connecting portion 154 includes a fixing piece 154a to be fixed to the lower surface of the accommodating portion 151, and a pair of connecting pieces 154b extending downward from both end portions of the fixing piece 154a in the lateral direction. Holes 154c penetrating in the lateral direction are provided in the connecting pieces 154b.

In the front radar assembly 100F as described above, the radar main body 110 and the attenuator 120 are accommodated in the space defined by the radar cover 130 and the attachment stay 150. In the front radar assembly 100F, the emission surface 111 of the radar main body 110 is covered with the radar cover 130, so that adhesion of foreign matter such as mud to the emission surface 111 can be prevented, and accuracy of detection using radio waves can be increased. Also, the radar main body 110 and the attenuator 120 are covered with radar cover 130, so that the appearance can be improved.

Further, as the respective structural elements of the front radar assembly 100F are integrated into an assembly, attachment properties with respect to the tractor 1 can be improved. Also, in the present example embodiment, the radar main body 110 and the attenuator 120 are fixed to the attachment stay 150, so that the position of attachment of the attenuator 120 with respect to the radar main body 110 can be less likely to vary.

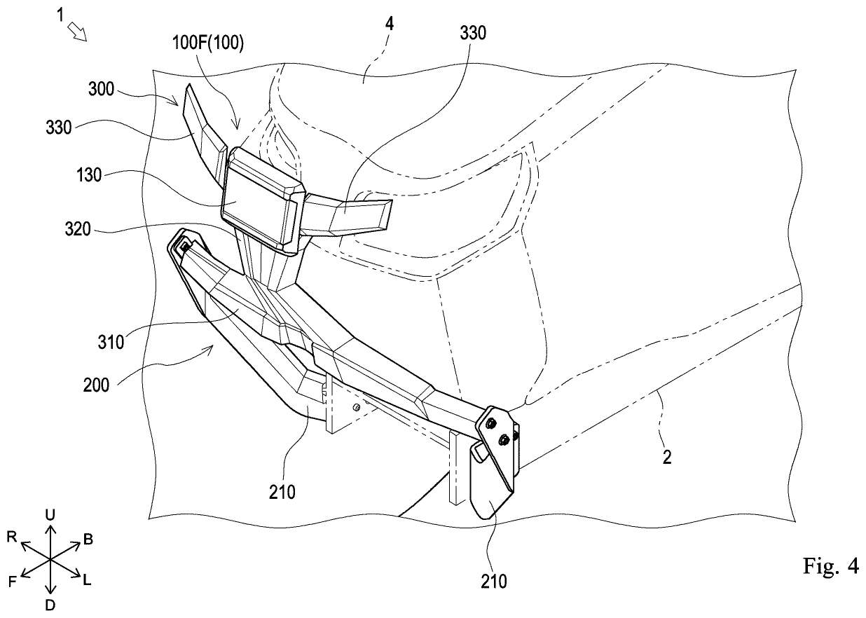

As shown in FIGS. 4 and 5, the front radar assembly 100F is attached to the vehicle body of the tractor 1 by the front support 200. Further, the front surface of the front support 200 is covered with a design cover 300. In the following description, the front support 200 and the design cover 300 are described.

The front support 200 shown in FIGS. 4, 5, and 7 is fixed to the vehicle body of the tractor 1, and supports the front radar assembly 100F. Specifically, the front support 200 is fixed to a portion of the vehicle body below the hood 4 (a front portion of the machine body frame 2 in the present example embodiment), and supports the front radar assembly 100F to be located in front of the hood 4. The front support 200 includes first portions 210, a second portion 220, and a third portion 230.

The first portions 210 are portions fixed to the front portion of the machine body frame 2. A pair of the first portions 210 is located on both the left and right sides of the machine body frame 2. The pair of first portions 210 is fixed to the left and right side surfaces of the front portion of the machine body frame 2 with bolts or the like. The first portions 210 each extend obliquely forward and upward from the front portion of the machine body frame 2. Further, the pair of first portions 210 are farther apart from each other at a higher position.

The second portion 220 is a portion that connects the upper ends of the pair of first portions 210 to each other. The second portion 220 is elongated in the lateral direction.

The third portion 230 extends upward from the second portion 220, and is a portion to which the front radar assembly 100F is connected. Specifically, the third portion 230 extends obliquely forward and upward from the central portion of the second portion 220 in the lateral direction. The third portion 230 is formed integrally with the second portion 220 by welding or the like. The third portion 230 includes a connecting portion 231 and cover support portions 232.

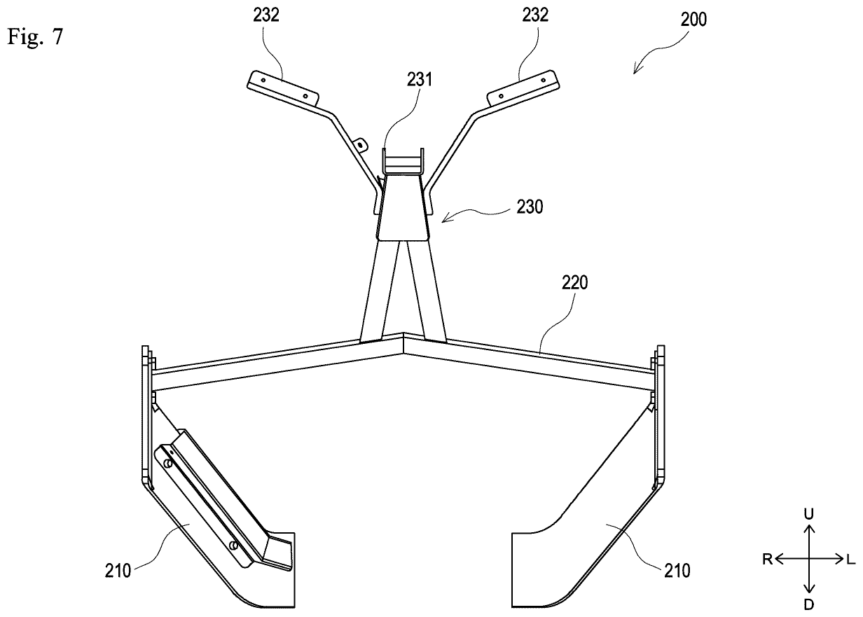

The connecting portion 231 shown in FIGS. 5 and 7 is the portion to which the front radar assembly 100F is connected. The connecting portion 231 defines the upper end of the third portion 230. The connecting portion 231 has holes 231a penetrating in the lateral direction. The connecting portion 231 is sandwiched between the pair of connecting pieces 154b of the connecting portion 154 of the attachment stay 150. In this state, the holes 231a of the connecting portion 231 and the holes 154c of the connecting pieces 154b overlap each other in a side view. In the present example embodiment, a fastening portion 231b formed with a bolt and a nut or the like is inserted into the holes 231a and the holes 154c, to connect the attachment stay 150 to the connecting portion 231.

The cover support portions 232 are portions that support third covers 330 of the design cover 300 described later. A pair of the cover support portions 232 is located on both the left and right sides of the upper portion of the third portion 230. The pair of cover support portions 232 extends upward from the central portion of the third portion 230 in the lateral direction, and are farther apart from each other at a higher position.

The front radar assembly 100F is connected to the front support 200 so as to be able to adjust the position of rotation, with the center of rotation being a rotating shaft extending in the lateral direction. Specifically, in a state where fastening by the fastening portion 231b, which is the rotating shaft, has been canceled, the front radar assembly 100F can change the position of rotation with respect to the front support 200. In a state where fastening has been performed by the fastening portion 231b, on the other hand, the position of rotation of the front radar assembly 100F with respect to the front support 200 is fixed. In the present example embodiment, the position of rotation of the front radar assembly 100F is set so that the emission surface 111 faces slightly upward with respect to level ground (so that the elevation angle is adjusted to about 10°, for example).

The design cover 300 shown in FIGS. 3 to 5 covers the front surface of the front support 200. Specifically, the design cover 300 covers the front surfaces of the second portion 220 and the third portion 230 of the front support 200. Note that, in FIG. 3, the design cover 300 is shaded. The design cover 300 does not block the front surface of front radar assembly 100F. The design cover 300 is made of resin or the like, for example. The design cover 300 is fixed to the front support 200 with fasteners such as bolts. The design cover 300 includes a first cover 310, a second cover 320, and the third covers 330.

The first cover 310 is a portion that covers the second portion 220 of the front support 200. The first cover 310 preferably has a shape corresponding to that of the second portion 220.

The second cover 320 is a portion that covers a portion of the third portion 230 of the front support 200 excluding the cover support portion 232. The second cover 320 preferably has a shape corresponding to that of the portion of the third portion 230. Also, the second cover 320 does not block the working lamps 4b and the headlights 4c on the front surface of the hood 4 in a front view. Specifically, the second cover 320 is located between the left and right working lamps 4b and the headlights 4c, and does not overlap the working lamps 4b and the headlights 4c on the front surface of the hood 4 in a front view.

The third covers 330 are portions that cover the front surfaces of the cover support portions 232. The third covers 330 define the upper end of the design cover 300. The third covers 330 extend from the portion at which the front radar assembly 100F is located (the central portion of the design cover 300 in the lateral direction), to both sides in the lateral direction.

As shown in FIG. 3, the third covers 330 preferably have a shape corresponding to that of the upper end of the front surface of the hood 4 in a front view. Specifically, the third covers 330 preferably have shapes corresponding to those of boundary portions between the front surface and the upper surface of the hood 4. The left and right third covers 330 preferably have shapes that are inclined upward at outer positions in the lateral direction. The upper ends of the left and right third covers 330 are located at higher positions than the front radar assembly 100F.

Also, the third covers 330 are visually recognizable from the driver seated on the seat 20 in the cabin 10. The driver can use the end portions of the third covers 330 in the lateral direction as the guides in driving the tractor 1. The third covers 330 according to the present example embodiment can be used as marks indicating a ridge width or the like.

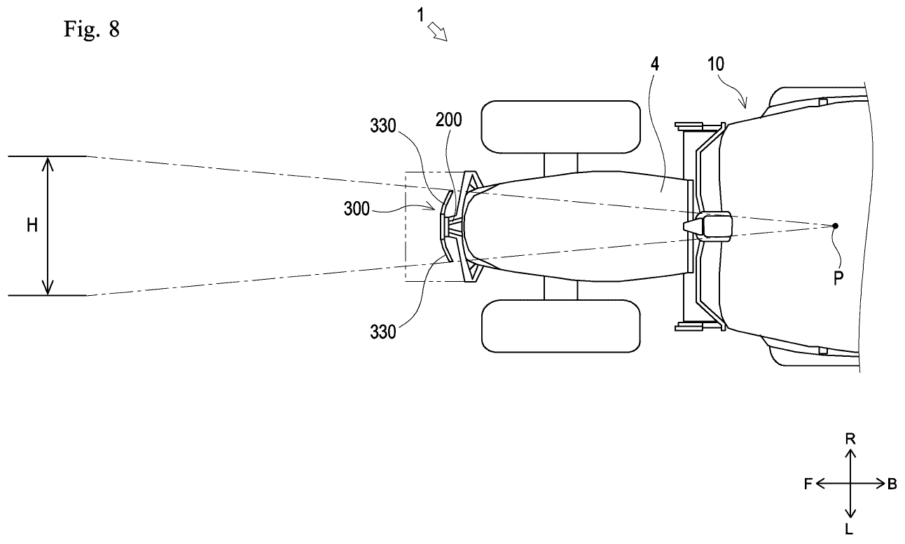

Specifically, as shown in FIG. 8, in a case where a pair of straight lines connecting the point of view P of the driver seated on the seat 20 and the end portions of the third covers 330 in the lateral direction is extended frontward in a planar view, the lateral distance between the pair of straight lines matches a lateral width H (a ridge width, for example) at a certain point in front of the tractor 1. In this case, as viewed from the driver, the lateral width of the third covers 330 substantially matches the lateral width H at a certain point in front of the tractor 1. Thus, the driver can drive the tractor 1, using the third covers 330 as a mark indicating the ridge width at a certain point in front of the tractor 1. Note that the lateral dimension of the third covers 330 can be set as appropriate, with the ridge width or the like being taken into consideration.

As the design cover 300 described above is provided, the front support 200 can be prevented from being exposed, and the appearance can be improved. Furthermore, in the present example embodiment, the third covers 330 preferably have a shape corresponding to that of the front surface of the hood 4 in a front view, so that the appearance can be further improved.

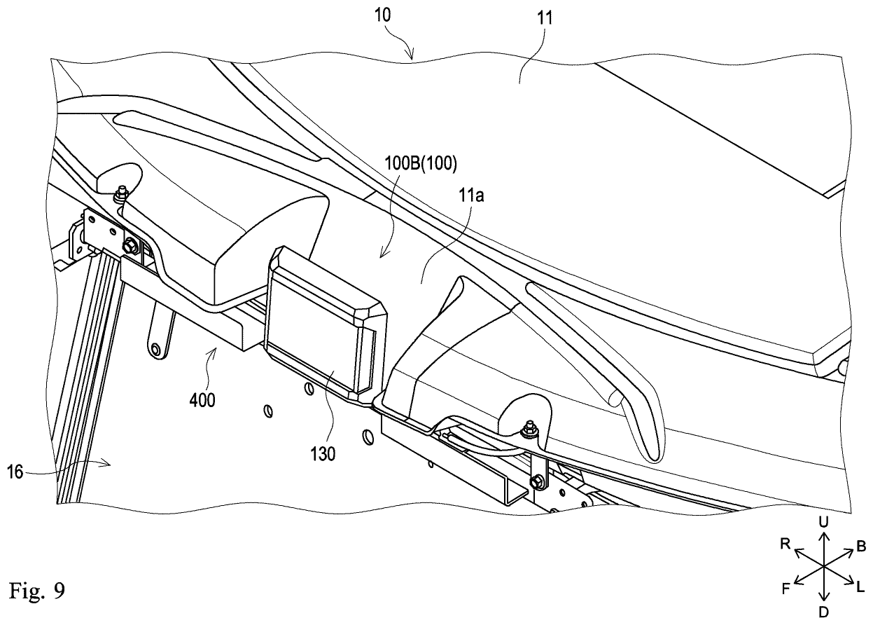

Next, the back radar assembly 100B is described with reference to FIGS. 9 to 11. The back radar assembly 100B can detect a detection target that is present behind the tractor 1. Note that the configuration of the back radar assembly 100B is the same as that of the front radar assembly 100F. Therefore, the placement and attachment modes of the back radar assembly 100B are mainly described below, and explanation of the configuration of the back radar assembly 100B is omitted.

The back radar assembly 100B is located on a rear portion of the roof 11 of the cabin 10. Specifically, the back radar assembly 100B is provided in a recess 11a that is recessed frontward at the center of the rear portion of the roof 11 in the lateral direction. The back radar assembly 100B faces substantially backward. With this arrangement, the back radar assembly 100B can perform detection in a detection range (a back detection range X2) behind the cabin 10 (see FIGS. 1 and 15).

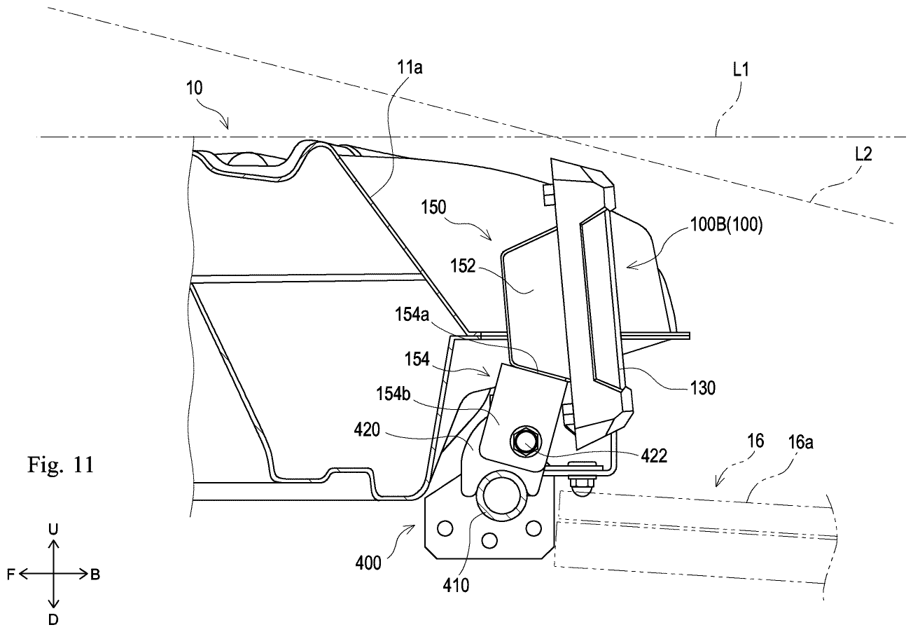

As shown in FIGS. 10 and 11, the back radar assembly 100B is attached to the vehicle body of the tractor 1 by a back support 400. In the following, the back support 400 is described.

The back support 400 is fixed to the vehicle body of the tractor 1, and supports the back radar assembly 100B. Specifically, the back support 400 is fixed to a rear portion of the rear beam 15 of the cabin 10 of the tractor 1, and supports the back radar assembly 100B to be located in the recess 11a of the roof 11. The back support 400 includes a support frame 410 and a connecting portion 420.

The support frame 410 shown in FIG. 10 is a portion fixed to the rear portion of the rear beam 15. The support frame 410 is elongated in the lateral direction. Both ends of the support frame 410 in the lateral direction are fixed to the pair of stays 15a provided on the rear beam 15 with bolts or the like (see FIG. 2).

The connecting portion 420 is a portion to which the back radar assembly 100B is connected. The connecting portion 420 is provided substantially at the center of the support frame 410 in the lateral direction. The connecting portion 420 has holes 421 penetrating in the lateral direction. The connecting portion 420 is sandwiched between the pair of connecting pieces 154b of the connecting portion 154 of the attachment stay 150. In this state, the holes 421 of the connecting portion 420 and the holes 154c of the connecting pieces 154b overlap in a side view. In the present example embodiment, a fastening portion 422 including a bolt and a nut or the like is inserted into the holes 421 and the holes 154c, to connect the attachment stay 150 to the connecting portion 420.

The back radar assembly 100B is connected to the back support 400 so as to be able to adjust the position of rotation, with the center of rotation being a rotating shaft extending in the lateral direction. Specifically, in a state where fastening by the fastening portion 422, which is the rotating shaft, has been canceled, the back radar assembly 100B can change the position of rotation with respect to the back support 400. In a state where fastening has been performed by the fastening portion 422, the position of rotation of the back radar assembly 100B with respect to the back support 400 is fixed. In the present example embodiment, the position of rotation of the back radar assembly 100B is set so that the emission surface 111 faces slightly upward with respect to level ground (so that the elevation angle is adjusted to about 5°, for example).

As the back support 400 positions the back radar assembly 100B at the height of the roof 11, any working device provided behind the vehicle body can be prevented from being located in the back detection range X2 of the back radar assembly 100B (see FIG. 1). Thus, the back radar assembly 100B can be prevented from erroneously detecting a working device.

Also, as shown in FIG. 11, the back support 400 supports the back radar assembly 100B so that the back radar assembly 100B accommodated in the recess 11a of the roof 11 is located at a position lower than the height of the roof 11. More specifically, the back support 400 supports the back radar assembly 100B to be located below a horizontal overall height line L1. Here, the horizontal overall height line L1 indicates the maximum height (the height of the upper end) of the roof 11 of the tractor 1 in a substantially horizontal posture. As the back radar assembly 100B is located below the horizontal overall height line L1, when the tractor 1 is put into a container that is used for transportation, or into a garage or the like, for example, the back radar assembly 100B can be prevented from coming into contact with the ceiling of the container or the like.

Further, in the present example embodiment, the back support 400 supports the back radar assembly 100B to be located below an inclined overall height line L2. Here, the inclined overall height line L2 indicates the maximum height (the height of the upper end) of the tractor 1 in a state where the tractor 1 is inclined so that the rear portion of the roof 11 is located at a higher position than the front portion of the roof 11. The inclined overall height line L2 is set on the basis of the angle of inclination of a gangplank placed between a container or the like and the ground when the tractor 1 is loaded into or unloaded from the container on the loading platform of a transportation unit. In the present example embodiment, the inclined overall height line L2 is set to indicate the maximum height of the tractor 1 inclined by about 15° with respect to level ground, for example. As the back radar assembly 100B is located at a position lower than the inclined overall height line L2, the tractor 1 can be prevented from coming into contact with the ceiling of a container or the like when the tractor 1 is inclined and is put into the container.

Furthermore, in the present example embodiment, in a state where a wiper 16a provided on the rear hatch 16 is operated while the rear hatch 16 of the cabin 10 of the tractor 1 is fully open, the back radar assembly 100B is located at a position higher than the wiper 16a of the rear hatch 16 in the fully opened state, so that the wiper 16a and the back radar assembly 100B do not interfere with each other.

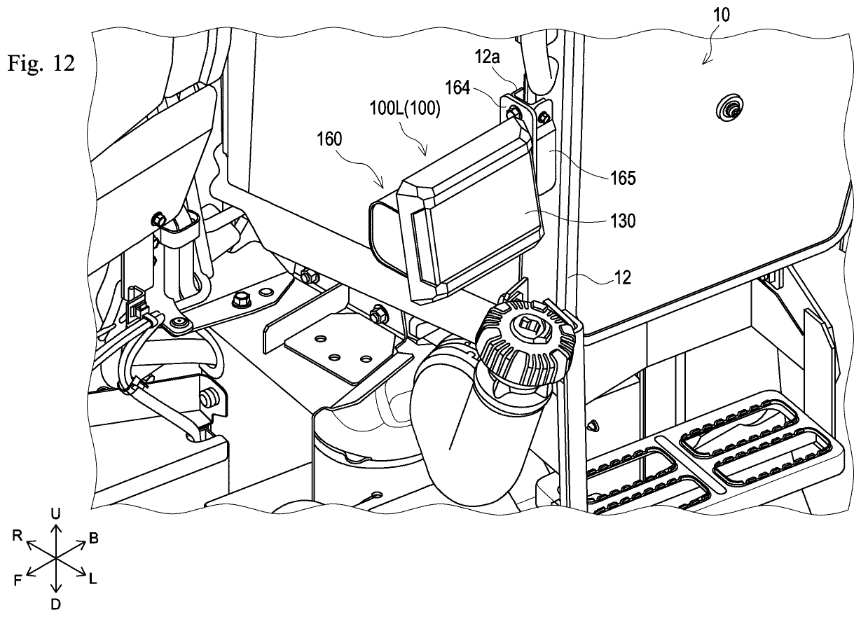

Next, the left radar assembly 100L and the right radar assembly 100R are described with reference to FIGS. 12 and 13. The left radar assembly 100L and the right radar assembly 100R can detect detection targets that are present on the left and right sides of the tractor 1.

The left radar assembly 100L and the right radar assembly 100R are located on the left and right sides of the cabin 10, respectively. Specifically, the left radar assembly 100L and the right radar assembly 100R are attached to the pair of left and right front pillars 12, respectively. The left radar assembly 100L and the right radar assembly 100R face substantially leftward and rightward. With this arrangement, the left radar assembly 100L and the right radar assembly 100R can perform detection in a detection range (a left detection range X3L) on the left side of the cabin 10 and a detection range (a right detection range X3R) on the right side of the cabin 10 (see FIGS. 2 and 15).

The left radar assembly 100L and the right radar assembly 100R each include a radar main body 110, an attenuator 120, a radar cover 130, a seal 140, and an attachment stay 160. Here, of the respective components, the portions excluding the attachment stay 160 (the portions being the radar main body 110, the attenuator 120, the radar cover 130, and the seal 140) are the same as the portions constituting the front radar assembly 100F.

Furthermore, the left radar assembly 100L and the right radar assembly 100R are symmetrical to each other. Specifically, in the left radar assembly 100L and the right radar assembly 100R, the respective attachment stays 160 preferably have shapes that are bilaterally symmetrical to each other, and the portions (the radar main body 110, the attenuator 120, the radar cover 130, and the seal 140) excluding the attachment stay 160 are the same between the two units. Hereinafter, the attachment stay 160 of the left radar assembly 100L will be referred to as the “attachment stay 160L”, and the attachment stay 160 of the right radar assembly 100R will be referred to as the “attachment stay 160R” (see FIGS. 3 and 13).

Since the left radar assembly 100L and the right radar assembly 100R are symmetrical to each other as described above, the left radar assembly 100L is mainly described below, and explanation of the right radar assembly 100R is omitted where appropriate. Also, in the description below, the configuration of the attachment stay 160L is mainly explained, and explanation of the already described other portions (the radar main body 110, the attenuator 120, the radar cover 130, and the seal 140) is omitted.

The attachment stay 160L shown in FIGS. 13 and 14 has the radar main body 110, the attenuator 120, and the radar cover 130 fixed thereto, and is attached to the front pillar 12. The attachment stay 160L has the radar main body 110 attached thereto so that the emission surface 111 of the radar main body 110 faces slightly upward with respect to level ground (so that the elevation angle is adjusted to about 10°). The attachment stay 160L is made of a metallic material. The attachment stay 160L includes an accommodating portion 161, a radar fixing portion 162, cover fixing portions 163, and an attachment portion 164.

The accommodating portion 161 is a portion that accommodates the radar main body 110. The accommodating portion 161 is substantially box-shaped that is open in the direction (obliquely upward and leftward) in which the emission surface 111 of the radar main body 110 faces. The accommodating portion 161 includes an upper wall 161a that is the wall on the upper side, a lower wall 161b that is the wall on the lower side, a front wall 161c that is the wall on the front side, a back wall 161d that is the wall on the back side, and a non-opening wall 161e that is the wall on the opposite side (right side) to the opening.

Of the respective walls, the non-opening wall 161e has a surface extending in a substantially vertical direction. Meanwhile, the upper wall 161a and the lower wall 161b have surfaces extending in a substantially horizontal direction. Further, the rim portion of the opening formed by the upper wall 161a, the lower wall 161b, the front wall 161c, and the back wall 161d of the accommodating portion 161 is substantially parallel to the emission surface 111 of the radar main body 110. Also, on the right side of the back wall 161d, a drawing opening 161f through which wiring lines of the radar main body 110 can be drawn out is provided.

The radar fixing portion 162 is a portion to fix the radar main body 110 in the accommodating portion 161. The radar fixing portion 162 preferably has in a substantially plate-like shape. The radar fixing portion 162 is inclined with respect to the non-opening wall 161e so that the surface to which the radar main body 110 is fixed faces obliquely upward and leftward. The radar fixing portion 162 is fixed to the upper wall 161a and the lower wall 161b by welding or the like. The radar main body 110 is fixed to the radar fixing portion 162 with fasteners such as bolts. The radar main body 110 is fixed to the radar fixing portion 162, and positioned such that the emission surface 111 faces obliquely upward and leftward with respect to level ground (so that the elevation angle is adjusted to about 10°, for example).

The cover fixing portions 163 are portions to fix the radar cover 130. The cover fixing portions 163 extend upward and downward from the opening of the accommodating portion 161. Specifically, the cover fixing portions 163 extend upward and downward from the left ends of the upper wall 161a and the lower wall 161b so as to be substantially parallel to the radar fixing portion 162, and preferably have a substantially plate-shaped configuration, with the plate surfaces facing substantially diagonally upward and leftward. The radar cover 130 is fixed to the cover fixing portions 163 with fasteners such as bolts. The seal 140 is located between the cover fixing portions 163 and the radar cover 130.

Note that, unlike the attachment stay 150 (see FIG. 6), the grommet 151b to be provided in the cutout 151a is not provided for the attachment stay 160. Therefore, any cutout for avoiding the grommet 151b is not formed in the seal 140 of the left radar assembly 100L.

The attachment portion 164 is a portion that is attached to the front pillar 12. The attachment portion 164 is fixed to the rear portion of the accommodating portion 161. Specifically, the attachment portion 164 is fixed to the accommodating portion 161 so as to cover the drawing opening 161f of the back wall 161d. The attachment portion 164 preferably is substantially plate-shaped, with the plate surface facing the front-back direction. The attachment portion 164 preferably has a rectangular shape that is long in the vertical direction in a front view. The attachment portion 164 includes a first fixing hole 164a, a second fixing hole 164b, and a wiring drawing hole 164c.

The first fixing hole 164a is located in the upper portion of the attachment portion 164. The first fixing hole 164a penetrates the upper portion of the attachment portion 164.

The second fixing hole 164b is located in the lower portion of the attachment portion 164. The second fixing hole 164b penetrates the lower portion of the attachment portion 164. The second fixing hole 164b is has an elongated hole shape extending in the lateral direction. More specifically, the second fixing hole 164b preferably has a substantially arc-like shape along the circumference centered on the first fixing hole 164a.

The wiring drawing hole 164c is a hole through which the wiring lines of the radar main body 110 can be drawn out. The wiring drawing hole 164c penetrates the central portion of the attachment portion 164 in the vertical direction. The wiring drawing hole 164c communicates with the space inside the accommodating portion 161. A cylinder through which the wiring lines are inserted in the accommodating portion 161 is connected to the wiring drawing hole 164c.

The attachment portion 164 is attached to the left front pillar 12 with fasteners such as bolts. As shown in FIG. 13, a pair of fixing portions 12a is provided on the front pillar 12 in the vertical direction. Engagement holes 12b to be engaged with the fasteners are provided in the fixing portions 12a. A communicating hole 12c that communicates with the space in the front pillar 12 is provided between the upper and lower fixing portions 12a. A grommet to protect the wiring lines is provided as appropriate in the communicating hole 12c.

As shown in FIGS. 13 and 14, the fasteners inserted into the first fixing hole 164a and the second fixing hole 164b of the attachment portion 164 are engaged with the engagement holes 12b of the front pillar 12, so that the left radar assembly 100L can be attached to the front pillar 12. As the second fixing hole 164b preferably has an elongated shape in the present example embodiment, the position of rotation of the left radar assembly 100L with respect to the front pillar 12 (the position of rotation with the first fixing hole 164a as the center of rotation) can be adjusted within the region of the second fixing hole 164b. Accordingly, the position of the left radar assembly 100L can be adjusted so that the non-opening wall 161e extends in a substantially vertical direction, and the upper wall 161a and the lower wall 161b extend in a substantially horizontal direction.

Further, in a state where the left radar assembly 100L is attached to the front pillar 12, the wiring lines drawn out from the wiring drawing hole 164c of the attachment portion 164 can be inserted into the space in the front pillar 12 through the communicating hole 12c. In the present example embodiment, a cover portion 165 that covers the space between the upper and lower fixing portions 12a from the left side is provided for the fixing portions 12a. The cover portion 165 preferably is substantially plate-shaped, with the plate surface facing substantially the lateral direction. As the cover portion 165 is provided, the wiring lines drawn out from the left radar assembly 100L can be made inconspicuous, and the appearance can be improved.

As shown in FIG. 14, in the left radar assembly 100L as described above, the radar main body 110 and the attenuator 120 are accommodated in the space defined by the radar cover 130 and the attachment stay 160. In the left radar assembly 100L, the emission surface 111 of the radar main body 110 and the covering portion 131 of the radar cover 130 are substantially in parallel with each other. With this arrangement, the accuracy of detection by the radar main body 110 can be increased.

The configuration and the attachment mode of the left radar assembly 100L have been described. The right radar assembly 100R is symmetrical to the left radar assembly 100L, and is attached to the right front pillar 12 in substantially the same manner as the left radar assembly 100L. The angle of the emission surface 111 of the right radar assembly 100R is set to substantially the same angle as that in the left radar assembly 100L. That is, the right radar assembly 100R is provided so that the elevation angle is about 10° with respect to level ground, for example.

As the respective radio wave emission surfaces 111 of the left radar assembly 100L and the right radar assembly 100R face obliquely upward as described above, it is possible to prevent erroneous detection of a structure provided on one side of the tractor 1. Examples of the structure include an oil feed port for fuel and the front wheels 6. The angles of the left radar assembly 100L and the right radar assembly 100R can be set as appropriate so that the structure is out of the left detection range X3L and the right detection range X3R.

Further, in the present example embodiment, the attachment portions 164 of the left radar assembly 100L and the right radar assembly 100R are provided so that each non-opening wall 161e extends in a substantially vertical direction, and each upper wall 161a and each lower wall 161b extend in a substantially horizontal direction. With this arrangement, it is possible to avoid giving the user an impression that the left radar assembly 100L and the right radar assembly 100R are attached in an inclined manner, while directing each emission surface 111 to face obliquely upward.

The tractors 1 according to the present example embodiments have been described so far. According to the present example embodiment, a wide area around the tractor 1 can be detected with each radar assembly 100 Also, results of detection performed by the respective radar assemblies 100 can be utilized in controlling driving of the vehicle and the like.

FIG. 15 shows the detection ranges (the front detection range X1, the back detection range X2, the left detection range X3L, and the right detection range X3R) of the respective radar assemblies 100. As shown in FIG. 15, the detection ranges of adjacent radar assemblies 100 among the respective radar assemblies 100 are designed to overlap each other. Thus, the surroundings of the tractor 1 can be suitably detected.

Note that, in the example shown in FIG. 15, blind spots for the detection ranges are located near the hood 4 and the cabin 10. In the present example embodiment, it is possible to detect a person or the like by capturing an image of the blind spots in the detection ranges, using a plurality of cameras (the front camera 51, the side cameras 52, and the back cameras 53) provided in the cabin 10. Thus, it is possible to control driving of the vehicle, using both the results of detection performed by the respective radar assembly 100s and the result of imaging performed by the plurality of cameras.

Also, in the present example embodiment, the radar main body 110, the attenuator 120, the radar cover 130, and the seal 140 are common structural elements among the respective radar assemblies 100. Thus, the radar assemblies 100 can use each other's structural elements mentioned above, and cost reduction can be achieved.

As described above, the tractor 1 (working vehicle) according to the present example embodiment is a working vehicle including the radar assembly 100 (detector) to detect a detection target around the vehicle body. The radar assembly 100 includes the radar main body 110 (radar) to emit radio waves to be used for detection, the attachment stay 150 (160) to which the radar main body 110 is fixed, and which is attached to the vehicle body, and the radar cover 130 that is fixed to the attachment stay 150 (160), covers the emission surface 111 of the radar main body 110 to emit the radio waves, and is capable of transmitting the radio waves.

With this configuration, detection of a detection target can be suitably performed using radio waves. Specifically, the emission surface 111 of the radar main body 110 provided in the vehicle body is covered with the radar cover 130, so that adhesion of foreign matter such as mud to the emission surface 111 can be prevented, and accuracy of detection using radio waves can be increased.

Further, as the radar main body 110, the radar cover 130, and the attachment stay 150 (160) are integrated into the radar assembly 100, attachment properties with respect to the vehicle body can be improved.

The tractor 1 also includes the seal 140 that closes a gap between the radar cover 130 and the attachment stay 150 (160).

With such a configuration, the seal 140 is provided, and thus, it is possible to prevent dust and water from entering a gap between the radar cover 130 and the attachment stay 150 (160).

Further, in the radar cover 130, the thickness of the portion (covering portion 131) through which the radio waves pass is uniform.

With such a configuration, the accuracy of detection using radio waves can be further increased.

The tractor 1 also includes the attenuator 120 TO attenuate a sidelobe wave generated on the outer side of a detection range and included in the radio waves emitted by the radar.

With such a configuration, the accuracy of detection using radio waves can be further increased. Specifically, as the attenuator 120 capable of attenuating sidelobe waves is provided, it is possible to prevent erroneous detection of the structure of the tractor 1, an attached working machine, the ground, or the like, due to a sidelobe wave.

Further, the attenuator 120 includes the main body portion 121 including a detection range surface (inner surface) extending along the detection range of the radar main body 110, and the radio wave absorbers 122 provided on the detection range surface.

With such a configuration, it is possible to prevent detection of a structure or the like outside the detection range, and further increase accuracy of detection.

The tractor 1 also includes the rivets 123 (insertion portions) that are inserted into the holes 121a and 122a in the main body portion 121 and the radio wave absorbers 122.

With such a configuration, it is possible to position the radio wave absorbers 122 (RAM) with respect to the main body portion 121 (resin guide), using the rivets 123.

The radar assembly 100 also includes the front radar assembly 100F (front detector) provided on the front side of the vehicle body, and the back radar assembly 100B (back detector) provided on the back side of the vehicle body.

In the front radar assembly 100F and the back radar assembly 100B, at least the radar main bodies 110 or the radar covers 130 have a same configuration as each other.

With such a configuration, the front and back radar assemblies 100 can use each other's radar main body 110 and radar cover 130, and cost reduction can be achieved.

The radar assembly 100 also includes the left radar assembly 100L (left detector) provided on the left side of the vehicle body, and the right radar assembly 100R (right detector) provided on the right side of the vehicle body.

In the left radar assembly 100L and the right radar assembly 100R, at least the radar main bodies 110 or the radar covers 130 have a same configuration as each other.

With such a configuration, the left and right radar assemblies 100 can use each other's radar main body 110 and radar cover 130, and cost reduction can be achieved.

Also, as described above, the tractor 1 (working vehicle) according to the present example embodiment is the tractor 1 including the radar assembly 100 (detection device) to detect a detection target around the vehicle body by emitting radio waves.

The radar assembly 100 includes the front radar assembly 100F (front detection device) to detect the detection target in front of the vehicle body, the left radar assembly 100L and the right radar assembly 100R (side detection devices) to detect the detection target on a side of the vehicle body, and the back radar assembly 100B (back detection device) to detect the detection target behind the vehicle body.

With such a configuration, it is possible to detect a wide area around the vehicle. Also, results of detection performed by the respective radar assemblies 100 can be utilized in controlling driving of the vehicle and the like.

Further, the front radar assembly 100F is located in front of the hood 4 of the vehicle body.

With such a configuration, the front radar assembly 100F is located in front of the hood 4, and thus, a detection target in front of the vehicle body can be suitably detected.

The tractor 1 also includes the front support 200 (front support) that is fixed to the vehicle body below the hood 4 and supports the front radar assembly 100F.

With such a configuration, the front radar assembly 100F can be suitably supported in front of the hood 4. Specifically, the front support 200 supports the front radar assembly 100F from the lower side of the hood 4, and thus, the front radar assembly 100F can be prevented from blocking the view of the driver in the cabin 10.

The tractor 1 also includes the design cover 300 (front support cover) that covers the front side of the front support 200.

With such a configuration, the design cover 300 is provided, and thus, the appearance can be improved.

Further, the front support 200 and the design cover 300 preferably have shapes that do not overlap the working lamps 4b and the headlights 4c (illumination units) provided on the front surface of the hood 4 in a front view.

With such a configuration, the front support 200 and the design cover 300 can be provided, without blocking the light from the working lamps 4b and the headlights 4c of the hood 4.

Further, the design cover 300 includes the third covers 330 (guide portions) that can serve as a guide in driving the tractor 1 when viewed by the driver in the cabin 10.

With such a configuration, the tractor 1 can be easily driven.

Further, the third covers 330 extend from the central portion of the design cover 300 in the lateral direction, toward both sides in the lateral direction.

With such a configuration, the third covers 330 can be used as a guide indicating a ridge width or the like.

Further, the left radar assembly 100L and the right radar assembly 100R each include the radar main body 110 (radar) to emit the radio waves, and the attachment stay 160 to which the radar main body 110 is fixed, and which is attached to the vehicle body.

The attachment stay 160 includes the accommodating portion 161 that includes at least one of a vertical surface (a surface of the non-opening wall 161e) extending in a vertical direction and a horizontal surface (a surface of the upper wall 161a and the lower wall 161b) extending in a horizontal direction, and accommodates the radar main body 110 so that the emission surface 111 of the radar main body 110 to emit the radio waves faces obliquely upward.

With such a configuration, the direction of emission of the radio waves by the radar main body 110 is directed obliquely upward, and thus, it is possible to prevent erroneous detection of a structure on a side of the vehicle.

Also, as at least one of the vertical surface and the horizontal surface is provided in the accommodating portion 161 of the attachment stay 160, it is possible to avoid giving the user an impression that the left radar assembly 100L and the right radar assembly 100R are attached in an inclined manner, though the accommodated radar main body 110 faces obliquely upward.

Further, the recess 11a that is recessed frontward so as to accommodate the back radar assembly 100B therein is located in a rear portion of the roof 11 of the cabin 10 of the vehicle body.

The back radar assembly 100B accommodated in the recess 11a includes the back support 400 (back support) that supports the back radar assembly 100B so as to be located at a position lower than the height of the roof 11.

With such a configuration, the back radar assembly 100B is located at the height of the roof 11, and thus, it is possible to prevent erroneous detection of a working device provided on a rear portion of the vehicle body. Also, as the back radar assembly 100B accommodated in the recess 11a is supported so as to be located at a position lower than the height of the roof 11, the back radar assembly 100B can be prevented from coming into contact with the ceiling of a container or the like when the tractor 1 is put into the container that is used for transportation of the tractor 1, for example.

Note that the radar assembly 100 according to the present example embodiment is an example embodiment of the detector according to the present invention.

Also, the front radar assembly 100F, the back radar assembly 100B, the left radar assembly 100L, and the right radar assembly 100R according to the present example embodiment are an example embodiment of the front detector, the back detector, the left detector, and the right detector according to the present invention.

Further, the radar main body 110 according to the present example embodiment is an example embodiment of the radar according to the present invention.

Also, the radar assembly 100 according to the present example embodiment is an example embodiment of the detection device according to the present invention.

Further, the front radar assembly 100F, the back radar assembly 100B, the left radar assembly 100L, and the right radar assembly 100R according to the present example embodiment are an example embodiment of the front detection device, the back detection device, and the side detection devices according to the present invention.

Also, the front support 200 according to the present example embodiment is an example embodiment of the front support according to the present invention.

Further, the design cover 300 according to the present example embodiment is an example embodiment of the front support cover according to the present invention.

Also, the working lamps 4b and the headlights 4c according to the present example embodiment are an example embodiment of the illumination units according to the present invention.

Further, the back support 400 according to the present example embodiment is an example embodiment of the back support according to the present invention.

Although some example embodiments of the present invention have been described above, the present invention is not limited to the above configurations, and various modifications can be made within the scope of the present invention.

For example, in the above example embodiments, the configurations in which each radar assembly 100 is located so as to face obliquely upward has been described as an example (see FIGS. 1 and 3), but the present invention is not limited to this. For example, a portion or a front portion of each radar assembly 100 may face in a substantially horizontal direction, or may face obliquely downward. The angle of each radar assembly 100 can be set as appropriate, depending on the detection mode.

Also, in the above example embodiments, the front radar assembly 100F and the back radar assembly 100B may have the same configurations as each other, but the present invention is not limited to this. For example, the front radar assembly 100F and the back radar assembly 100B may have different configurations from each other.

Also, in the above example embodiments, examples in which the attenuator 120 is attached to the attachment stay 150 (160) has been described, but the present invention is not limited to this. For example, the attenuator 120 may be attached to the radar cover 130.

Also, in the above example embodiments, examples in which the main body portion 121 (see FIG. 6) of the attenuator 120 including resin has been described, but the main body portion 121 may include metal or the like.

Further, in the above example embodiments, examples in which the radio wave absorbers 122 are provided on all of the four sidewalls of the main body portion 121 of the attenuator 120 has been described, but the present invention is not limited to this. For example, the radio wave absorbers 122 may be provided on any (one, for example) sidewall among the four sidewalls of the main body portion 121. In this case, the radio wave absorbers 122 may be provided only on the lower sidewall of the main body portion 121, for example.

Further, in the above example embodiments, examples in which the rivets 123 are inserted into the holes 121a of the main body portion 121 of the attenuator 120 and the holes 122a of the radio wave absorbers 122 has been described, but the present invention is not limited to this. For example, the radio wave absorbers 122 may be attached to the main body portion 121 only by adhesion using a double-sided tape, an adhesive, or the like, without the holes 121a, the holes 122a, and the rivets 123.

Further, in the above example embodiments, examples in which the sheet-like radio wave absorbers 122 are provided on the inner surfaces of the main body portion 121 to define the attenuator 120 has been described, but the present invention is not limited to this. For example, the main body portion 121 may include a material capable of absorbing radio waves, without the sheet-shaped radio wave absorbers 122.

Also, in the above example embodiments, examples in which the emission surface 111 of the radar main body 110 of each of the left radar assembly 100L and the right radar assembly 100R is substantially parallel to the covering portion 131 of the radar cover 130 has been described (see FIG. 14), but the present invention is not limited to this. For example, while the emission surface 111 of each radar main body 110 is positioned obliquely upward, the radar cover 130 may face the horizontal direction. In a case where the above configuration is adopted, it is possible to provide a sense of unity between the attachment stay 160 having surfaces extending in the horizontal direction and the vertical direction, and the radar cover 130.

Further, in the above example embodiments, a detection device using radio waves is adopted as each radar main body 110, but the present invention is not limited to this. For example, a detection device including a non-contact sensor that uses ultrasonic waves or the like other than radio waves may be adopted.

In addition to the above, the shape, structure, and the like of each of the components described in the above example embodiment are merely examples, and the configurations of each component can be changed as appropriate.

Also, in the above example embodiments, tractors 1 have been described as examples of working vehicles, but working vehicles are not limited to such a mode. For example, working vehicles may be some other agricultural vehicles, construction vehicles, industrial vehicles, or the like.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a detector to detect a detection target around a vehicle body, the detector including:
a radar to emit a radio wave to be used for detection;
an attachment stay to which the radar is fixed, and which is attached to the vehicle body; and
a radar cover that is fixed to the attachment stay, covers an emission surface of the radar, and is capable of transmitting the radio wave;
the emission surface being configured to emit the radio wave.

2. The working vehicle according to claim 1, further comprising a seal that closes a gap between the radar cover and the attachment stay.

3. The working vehicle according to claim 1, wherein, in the radar cover, a portion through which the radio wave passes has a uniform thickness.

4. The working vehicle according to claim 1, further comprising an attenuator to attenuate a sidelobe wave generated outside a detection range and included in the radio wave emitted by the radar.

5. The working vehicle according to claim 4, wherein the attenuator includes:
a main body portion including a detection range surface extending along the detection range of the radar; and
a radio wave absorber provided on the detection range surface.

6. The working vehicle according to claim 5, further comprising an insertion portion that is inserted into holes in the main body portion and the radio wave absorber.

7. The working vehicle according to claim 1, wherein the detector includes:
a front detector provided on a front side of the vehicle body; and
a back detector provided on a back side of the vehicle body; and
in the front detector and the back detector, at least one of the radar or the radar cover has a same configuration.

8. The working vehicle according to claim 1, wherein the detector includes:
a left detector provided on a left side of the vehicle body; and
a right detector provided on a right side of the vehicle body; and
in the left detector and the right detector, at least one of the radar or the radar cover has the same configuration.

9. The working vehicle according to claim 2, further comprising an attenuator to attenuate a sidelobe wave generated outside a detection range and included in the radio wave emitted by the radar.

10. The working vehicle according to claim 3, further comprising an attenuator to attenuate a sidelobe wave generated outside a detection range and included in the radio wave emitted by the radar.

11. The working vehicle according to claim 9, wherein the attenuator includes:
a main body portion including a detection range surface extending along the detection range of the radar; and
a radio wave absorber provided on the detection range surface.

12. The working vehicle according to claim 10, wherein the attenuator includes:
a main body portion including a detection range surface extending along the detection range of the radar; and
a radio wave absorber provided on the detection range surface.

13. The working vehicle according to claim 11, further comprising an insertion portion that is inserted into holes in the main body portion and the radio wave absorber.

14. The working vehicle according to claim 12, further comprising an insertion portion that is inserted into holes in the main body portion and the radio wave absorber.
